(19) United States
(12) Patent Application Publication
(10) Pub. No.: US 2013/0219088 A1
(43) Pub. Date: Aug. 22, 2013

(54) CONFIGURABLE PRIORITIZATION OF DATA TRANSMISSION IN A DATA STORAGE TOPOLOGY

(71) Applicants: Lawrence J. Rawe, Colorado Springs, CO (US); Gregory A. Johnson, Colorado Springs, CO (US); Willliam W. Voorhees, Colorado Springs, CO (US); Travis A. Bradfield, Colorado Springs, CO (US); Edoardo Daelli, Castle Rock, CO (US)

(72) Inventors: Lawrence J. Rawe, Colorado Springs, CO (US); Gregory A. Johnson, Colorado Springs, CO (US); Willliam W. Voorhees, Colorado Springs, CO (US); Travis A. Bradfield, Colorado Springs, CO (US); Edoardo Daelli, Castle Rock, CO (US)

(73) Assignee: LSI CORPORATION, Milpitas, CA (US)

(21) Appl. No.: 13/402,268

(22) Filed: Feb. 22, 2012

(51) Int. Cl. G06F 3/00

(52) U.S. Cl. 710/39

(57) ABSTRACT

Processing input/output requests may include: processing one or more input/output (IO) requests in a first IO queue associated with a first device group; detecting a queuing of one or more IO requests in a second IO queue associated with a second device group; pausing the processing one or more input/output (IO) requests in a first IO queue associated with a first device group upon a detection of a queuing of one or more IO requests in a second IO queue associated with a second device group; processing the one or more IO requests in a second IO queue associated with a second device group; and resuming the processing one or more input/output (IO) requests in a first IO queue associated with a first device group upon a completion of the processing the one or more IO requests in a second IO queue associated with a second device group.

### BACKGROUND

In the newest generation of serial attached SCSI (SAS) controllers, the concept of multiple transmission queues has been introduced. The multiple queuing designs have been added to enhance and improve the flow of data to devices out in the topology using specific data control techniques that rely on multiple queues. As a result of such multiple-queue designs, system firmware may lack the ability to insert a priority request ahead of every other request in the system as the other requests are spread across multiple queues.

During task management, topology discovery or error handling, it may be the case that a Serial Management Protocol (SMP) or Task IU request issued by firmware may need to take priority over all other requests. In prior generations, a single data transfer Queue was used. Every data out operation was placed on a single queue, and thus Firmware could simply put the SMP request at the head of that Queue to ensure prompt processing.

It should also be noted that all existing “priority” methods used on prior generation controllers involved Firmware placing an IO at the head of the Queue. This method required firmware intervention on each IO, and was therefore not applicable to a performance IO path.

A related challenge exists when a fixed round-robin priority scheme is used. In this case, there is no way to prioritize any devices, or even specific requests, as the existing implementation is completely round-robin. While there could be some gain made by placing a request at the head of a specific Queue, since all Queues are treated fairly the request would still have to wait until that specific Queue is serviced.

Finally, in both current and prior generations there has never been the capability to specifically prioritize a device (and all its IOs). Any prioritization was either IO specific, or attempted to leverage multiple (fairly serviced) Queues by putting the majority of devices in the “default” queue, and using another for higher priority devices. However, this method only leverages a “one vs. many”-type prioritization and does not specifically favor one Queue over the other. Additionally, the existing setups had to be hard coded at start of day and once set they could not be changed.

### SUMMARY

Systems and methods described herein may implement one or more operations for processing input/output requests according to prioritization of transmission queues. Such operations may include, but are not limited to: processing one or more input/output (IO) requests in a first IO queue associated with a first device group; detecting a queuing of one or more IO requests in a second IO queue associated with a second device group; pausing the processing one or more input/output (IO) requests in a first IO queue associated with a first device group upon a detection of a queuing of one or more IO requests in a second IO queue associated with a second device group; processing the one or more IO requests in a second IO queue associated with a second device group; and resuming the processing one or more input/output (IO) requests in a first IO queue associated with a first device group upon a completion of the processing the one or more IO requests in a second IO queue associated with a second device group.

### BRIEF DESCRIPTION OF DRAWINGS

The numerous advantages of the disclosure may be better understood by those skilled in the art by referencing the accompanying figures in which:

FIG. 1 shows a system for processing IO requests directed to one or more devices;

FIG. 2 shows a system for processing IO requests directed to one or more devices;

FIG. 3 shows a process flow diagram for IO requests; and

FIG. 4 shows a process flow diagram for IO requests.

### DETAILED DESCRIPTION

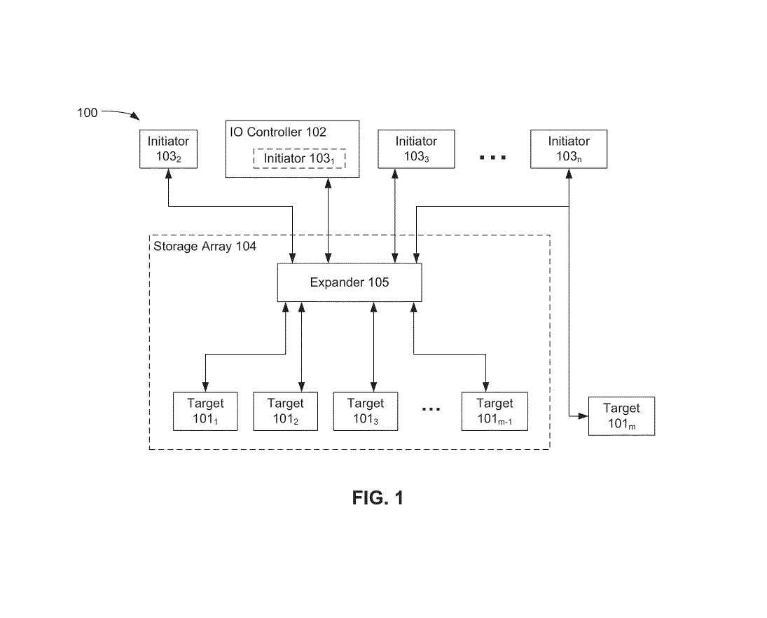

Referring to FIG. 1, a storage system 100 may include at least one target device 101 and at least one IO controller 102. The IO controller 102 may employ at least one initiator 103 (e.g. an initiator 103₁) to process various IO requests directed to the target devices 101. The target devices 101 may include devices having varying performance characteristics for servicing IO requests for varying priorities. For example, target devices 101 may include high-performance devices (e.g. solid state drives (SSDs)), standard magnetic hard disk drives (HDDs), and the like. Two or more target devices 101 may be aggregated to form a storage array 104. Access to the target devices 101 by the initiators 103 may be governed by an expander 105 which may arbitrate 10 requests by the various initiators 103.

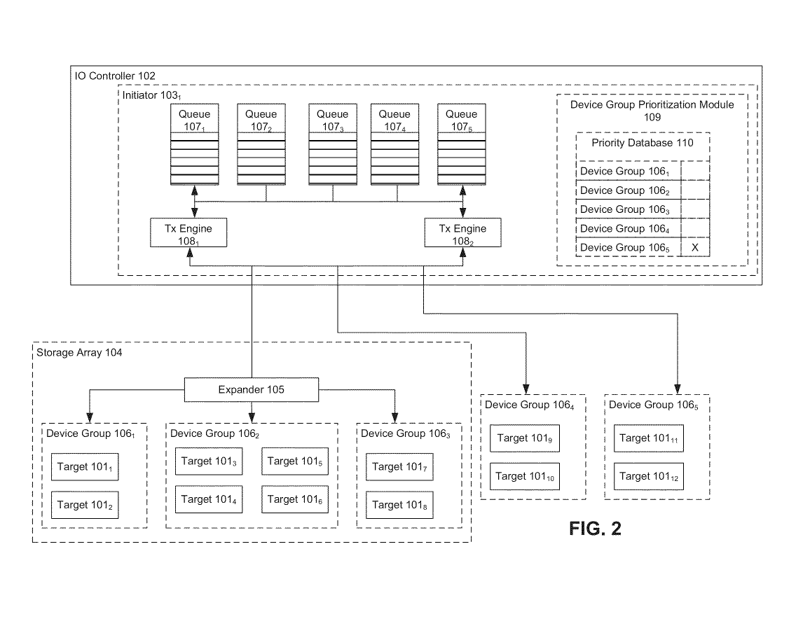

Within the storage system 100, each target device 101 may be included within a logical “group” of devices having similar performance characteristics. Each device found in the storage system can be placed into specific groups. For example, as shown in FIG. 2, target device 101₁ and target device 101₂ may be members of device group 106₁; target device 101₃, target device 101₄, target device 101₅ and target device 101₆ may be members of device group 106₂; and target device 101₇, target device 101₈, may be members of device group 106₃. Additionally, other target devices 101 which are not part of the storage array 104 may be partitioned into groups. For example, target device 101₉ and target device 101₁₀, may be members of device group 106₄; and target device 101₁₁ and target device 101₁₂ may be a member of device group 106₅.

Further, the IO controller 102 may maintain an IO queue 107 associated with each device group 106. For example, as shown in FIG. 2, the IO controller 102 may maintain queue 107₁-queue 107₅ for queuing IO requests directed to device groups device group 106₁-device group 106₅ respectively.

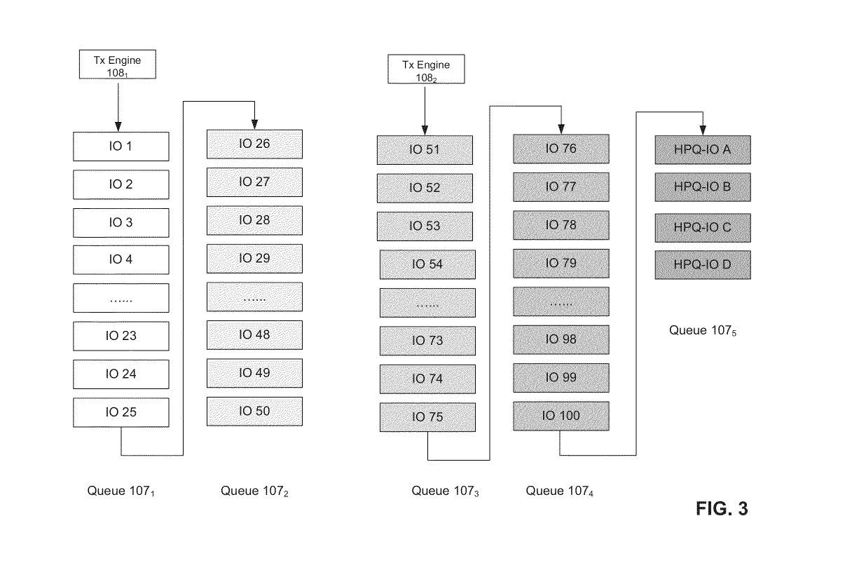

Still further, the IO controller 102 may employ at least one transmission engine 108 (e.g. Tx engine 108₁ and Tx engine 108₂). The TX engines 108 are processing units which pull IO requests off a queue 107 associated with a specific device group 106 and process those requests on the target devices 101 of the subject device group 106. Under normal operation, the TX engines 108 service each group in a round-robin ordering scheme such that every group is provided an equal amount of servicing time. For example, as shown in FIG. 3, Tx engine 108₁ may begin processing IO requests in queue 107₁ and, following completion of the IO requests in queue 107₁, continue processing IO requests in queue 107₂. Similarly, Tx engine 108₂ may begin processing IO requests in queue 107₃ and, following completion of the IO requests in queue 107₃, continue processing IO requests in queue 107₄.

A constraint with such a round-robin servicing approach may be that it does not allow for any prioritization of work for any particular target device 101 as every device/transfer must wait for its turn to be serviced by a Tx engine 108. In particular, if a device/group was just serviced, it may then have to wait until all other groups are worked on before the TX engines 108 come back to that device group 106 again. In larger configurations this could be an unacceptably long time when urgent data transfer is needed.

For example, it may be the case that high-priority queue (HPQ) IOs (e.g. HPQ-IO A, B, C, D in queue 107₅) need urgent processing on the target devices 101 associated with the device group 106₅. However, based on round-robin servicing and the use of two TX engines 108, a Tx engine 108 may be required to fully transmit the IO requests of two entire queues 107 before being available for processing the HPQ IOs in queue 107₅.

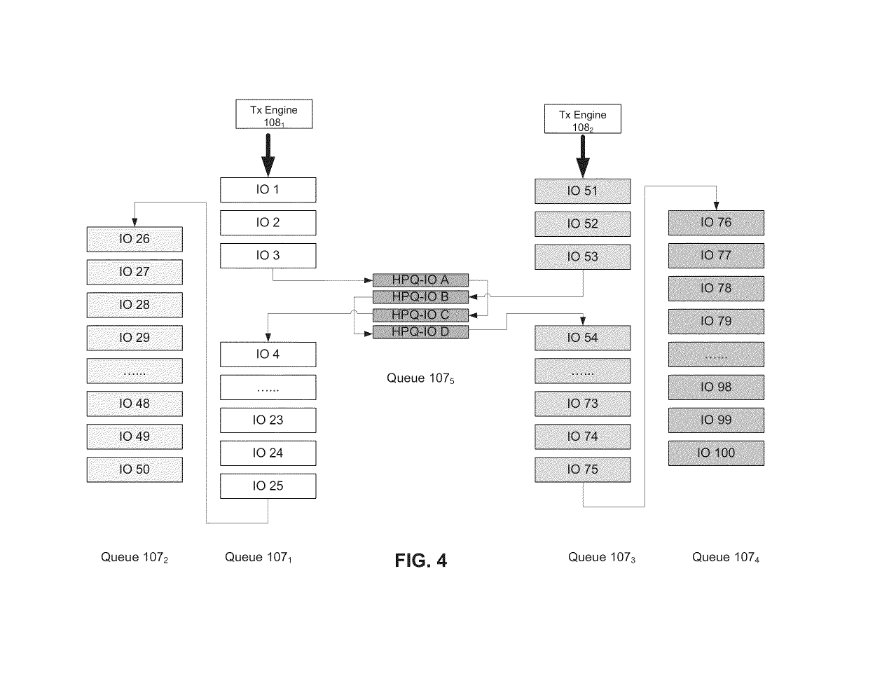

As such, the storage system 100 may provide for designating one or more device groups 106 as “high priority” and thus allow them to be serviced immediately (or within 1 IO delay) if there is data to be transferred to those device groups 106. Taking the above example, and applying the high priority mechanism to the HPQ IOs would result in the more favorable example shown in FIG. 4. As shown in FIG. 4, device group 106₅ may be designated (as described below) as a “high priority” device group 106 and correspondingly, IOs in queue 107₅ associated with device group 106₅ may be designated as a “high priority” HPQ IOs. It may be the case that HPQ-IO A, B, C and D appear in queue 107₅ at/around the time the Tx engine 108₁ and Tx engine 108₂ are processing IO 3 of queue 107₁ and IO 53 of queue 107₃, respectively. Once those IO's are completed, because the device group 106₅/queue 107₅ with the HPQ IOs is designated as high priority, the Tx engine 108₁ and/or Tx engine 108₂ may immediately switch to servicing those IOs for device group 106₅/queue 107₅. Once completed, processing by the Tx engine 108₁ and/or Tx engine 108₂ may return back to the device group 106/queue 107 that it had previously been servicing (e.g. IO 4 for device group 106₁/queue 107₁ and IO 54 for device group 106₃/queue 107₃, respectively). As shown in FIG. 4, both of the Tx engine 108₁ and Tx engine 108₂ may be transitioned to processing of the “high priority” device group 106₅/queue 107₅ to most efficiently complete the IO requests in the queue 107₅. However, it may be the case that only one of the Tx engine 108₁ and the Tx engine 108₂ may be transitioned to the processing of the “high priority” device group 106₅/queue 107₅. Further, the transition to processing of the “high priority” device group 106₅/queue 107₅ for the Tx engine 108₁ and Tx engine 108₂ need not occur contemporaneously. Such transitions may occur sequentially or intermittently depending on system resource requirements.

As can be seen, applying this high-priority designation and out-of-turn processing method may allow for the lowest latency processing of IOs for devices placed in “high priority” group(s).

While the above described priority processing functionality of the invention may be resident within the controller hardware directly, the ability to designate one or more groups as “high priority” is a capability that may be implemented at the firmware/software layers. This approach provides a large amount of flexibility as storage system configuration may vary greatly amongst different configurations. Additionally, within a given system the priority groups may change as loads change over time, and thus it would be advantageous to have a system capable of adapting over time to varying IO loads.

Referring again to FIG. 2, to allow for device group 106/queue 107 prioritization designations, the storage system 100 may include a device group prioritization module 109. The device group prioritization module 109 may employ one or more prioritization protocols in order to designate any of the N target devices 101 and/or device groups 106 groups as “high priority” at any time. The device group prioritization module 109 may maintain a priority database 110 (e.g. one or more software/firmware/hardware accessible read/write registers) configured to store one or more flags indicative of a designation of a device group 106/queue 107 as “high priority.” For example (and as further explained infra) the device group prioritization module 109 may prioritize groups according to: the type of target device 101, the type of data associated with a device group 106, quality of service parameters, and the like. Alternately, external system components (e.g. system hardware modules such as a configuration monitor or system debug access controller) may be granted access to the priority database 110 (e.g. through an Ethernet port, USB, parallel port, or serial port interfaced to the IO controller 102) to modify the respective priorities maintained by the priority database 110. A custom SMP command may be used to access the priority database 110. The software/firmware/hardware or external system components may use algorithms to dynamically change the contents of the priority database 110. The IO controller 102 may query the priority database 110 when processing IOs to determine if one or more IOs for a device group 106/queue 107 designated as “high priority” are queued in order to process those IOs in the out-of-turn manner described above. So long as a device group 106/queue 107 has its high priority flag set, it will be treated as described above with respect to FIG. 4. If the higher priority designation for a device group 106/queue 107 is no longer needed, the flag for that device group 106/queue 107 may be removed and the IO processing may return to normal round-robin processing as described above with respect to FIG. 3.

Some specific use cases of the above described systems and methods may include, but are not limited to the following examples.

In an exemplary embodiment, a “high priority” designation may be permanently assigned for a device group 106 that contains various device-types that would always need immediate transmission of data for topology management/maintenance. These could be devices such as expanders in a SAS topology that must receive SMP requests for things such as Task Management operations. In one case, a “high priority” designation may be permanently assigned for a device group 106 containing peer/partner controllers in an external storage type configuration. This would allow for faster transfer of critical data amongst storage controllers in such a configuration (such as cache information). In another case, a “high priority” designation may be permanently assigned for a device groups 106/queues 107 including certain higher performance target devices 101 such as SSD's. As the usage of SSD for various types of data cache increases, it may be desirable to treat data transfer to those target devices 101 with high priority versus other non-SSD target devices.

In another exemplary embodiment, a “high priority” designation for a device group 106/queue 107 may be automatically toggled “on” and “off” by the device group prioritization module 109 for a device group 106 known to regularly receive a “burst” of time critical data. Specifically, “high priority” IO requests for a device group 106/queue 107 may be received with a given periodicity. In such a case, the “high priority” designation for that device group 106/queue 107 may be automatically toggled “on” and “off” according to that periodicity.

In another exemplary embodiment, a “high priority” designation for a device group 106/queue 107 may be toggled “on” and “off” in order to maintain Quality of Service. If it is determined that a specific device group 106/queue 107 has not been serviced in a desired timeframe, the device group 106/queue 107 could be made “high-priority” automatically by the device group prioritization module 109. More specifically, “high priority” designations may have set “activity timers” that prevent high-priority device group 106/queue 107 servicing from starving device groups 106/queues 107 that are not designated as high priority. For example, the device group prioritization module 109 may maintain one or more timers/counters associated with the flags maintained by the priority database 110 designating one or more high-priority device groups 106/queues 107. The device group prioritization module 109 may compare a timer associated with a flag associated with a given high-priority device group 106 to a threshold value (e.g. an elapsed time, a number of IO requests processed, etc). Upon reaching the threshold value, the device group prioritization module 109 may automatically remove the flag associated with the high-priority device group 106 to allow for processing of other device groups 106/queues 107.

Further, though described above with respect to one “high priority” device group 106 designation, it will be noted that such “high priority” designations can be applied to more than one group at a time, therefore the method can be “scaled up” in large topologies where there are hundreds of groups.

It is believed that the present invention and many of its attendant advantages will be understood by the foregoing description. It may be also believed that it will be apparent that various changes may be made in the form, construction and arrangement of the components thereof without departing from the scope and spirit of the invention or without sacrificing all of its material advantages. The form herein before described being merely an explanatory embodiment thereof. It may be the intention of the following claims to encompass and include such changes.

The foregoing detailed description may include set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

In addition, those skilled in the art will appreciate that the mechanisms of the subject matter described herein may be capable of being distributed as a program product in a variety of forms, and that an illustrative embodiment of the subject matter described herein applies regardless of the particular type of signal bearing medium used to actually carry out the distribution. Examples of a signal bearing medium include, but may be not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

Those having skill in the art will recognize that the state of the art has progressed to the point where there may be little distinction left between hardware, software, and/or firmware implementations of aspects of systems; the use of hardware, software, and/or firmware may be generally (but not always, in that in certain contexts the choice between hardware and software may become significant) a design choice representing cost vs. efficiency tradeoffs. Those having skill in the art will appreciate that there may be various vehicles by which processes and/or systems and/or other technologies described herein may be effected (e.g., hardware, software, and/or firmware), and that the preferred vehicle will vary with the context in which the processes and/or systems and/or other technologies may be deployed. For example, if an implementer determines that speed and accuracy may be paramount, the implementer may opt for a mainly hardware and/or firmware vehicle; alternatively, if flexibility may be paramount, the implementer may opt for a mainly software implementation; or, yet again alternatively, the implementer may opt for some combination of hardware, software, and/or firmware. Hence, there may be several possible vehicles by which the processes and/or devices and/or other technologies described herein may be effected, none of which may be inherently superior to the other in that any vehicle to be utilized may be a choice dependent upon the context in which the vehicle will be deployed and the specific concerns (e.g., speed, flexibility, or predictability) of the implementer, any of which may vary. Those skilled in the art will recognize that optical aspects of implementations will typically employ optically oriented hardware, software, and or firmware.

What is claimed is:

1. A computer-implemented method comprising:
processing one or more input/output (IO) requests in a first IO queue associated with a first device group;
detecting a queuing of one or more IO requests in a second IO queue associated with a second device group;
pausing the processing one or more input/output (IO) requests in a first IO queue associated with a first device group upon a detection of a queuing of one or more IO requests in a second IO queue associated with a second device group;
processing the one or more IO requests in a second IO queue associated with a second device group; and
resuming the processing one or more input/output (IO) requests in a first IO queue associated with a first device group upon a completion of the processing the one or more IO requests in a second IO queue associated with a second device group.

2. The computer-implemented method of claim 1, further comprising:
designating a second IO queue as having an IO processing priority greater than that of a first IO queue.

3. The computer-implemented method of claim 2, wherein the designating a second IO queue as having an IO processing priority greater than that of a first IO queue comprises:
designating a second IO queue as having an IO processing priority greater than that of a first IO queue according to a device type of one or more devices of a device group associated with the second IO queue.

4. The computer-implemented method of claim 2, wherein the designating a second IO queue as having an IO processing priority greater than that of a first IO queue comprises:
designating a second IO queue as having an IO processing priority greater than that of a first IO queue according to a periodicity of one or more IO requests associated with the second IO queue.

5. The computer-implemented method of claim 2, wherein the designating a second IO queue as having an IO processing priority greater than that of a first IO queue comprises:
designating a second IO queue as having an IO processing priority greater than that of a first IO queue according to an IO processing metric.

6. The computer-implemented method of claim 5, wherein the designating a second IO queue as having an IO processing priority greater than that of a first IO queue according to an IO processing metric comprises:
designating a second IO queue as having an IO processing priority greater than that of a first IO queue according to at least one of: an elapsed time; and a number of processing operations completed.

7. The computer-implemented method of claim 2, wherein the designating a second IO queue as having an IO processing priority greater than that of a first IO queue comprises:
removing a designation of a second IO queue as having an IO processing priority greater than that of a first IO queue.

8. The computer-implemented method of claim 7, wherein the removing a designation of a second IO queue as having an IO processing priority greater than that of a first IO queue comprises:
removing a designation of a second IO queue as having an IO processing priority greater than that of a first IO queue according to an IO processing metric.

9. The computer-implemented method of claim 8, wherein removing a designation of a second IO queue as having an IO processing priority greater than that of a first IO queue comprises:
removing a designation of a second IO queue as having an IO processing priority greater than that of a first IO queue according to at least one of: an elapsed time; and a number of processing operations completed.

10. A system comprising:
means for processing one or more input/output (IO) requests in a first IO queue associated with a first device group;
means for detecting a queuing of one or more IO requests in a second IO queue associated with a second device group;
means for pausing the processing one or more input/output (IO) requests in a first IO queue associated with a first device group upon a detection of a queuing of one or more IO requests in a second IO queue associated with a second device group;
means for processing the one or more IO requests in a second IO queue associated with a second device group; and
means for resuming the processing one or more input/output (IO) requests in a first IO queue associated with a first device group upon a completion of the processing the one or more IO requests in a second IO queue associated with a second device group.

11. The system of claim 10, further comprising:
means for designating a second IO queue as having an IO processing priority greater than that of a first IO queue.

12. The system of claim 11, wherein the means for designating a second IO queue as having an IO processing priority greater than that of a first IO queue comprises:
means for designating a second IO queue as having an IO processing priority greater than that of a first IO queue according to a device type of one or more devices of a device group associated with the second IO queue.

13. The system of claim 11, wherein the means for designating a second IO queue as having an IO processing priority greater than that of a first IO queue comprises:
means for designating a second IO queue as having an IO processing priority greater than that of a first IO queue according to a periodicity of one or more IO requests associated with the second IO queue.

14. The system of claim 11, wherein the means for designating a second IO queue as having an IO processing priority greater than that of a first IO queue according to an IO processing metric comprises:
means for designating a second IO queue as having an IO processing priority greater than that of a first IO queue according to at least one of: an elapsed time; and a number of processing operations completed.

15. The system of claim 11, wherein the means for designating a second IO queue as having an IO processing priority greater than that of a first IO queue comprises:
means for removing a designation of a second IO queue as having an IO processing priority greater than that of a first IO queue.

16. The system of claim 15, wherein the means for removing a designation of a second IO queue as having an IO processing priority greater than that of a first IO queue comprises:
means for removing a designation of a second IO queue as having an IO processing priority greater than that of a first IO queue according to an IO processing metric.

17. The system of claim 16, wherein means for removing a designation of a second IO queue as having an IO processing priority greater than that of a first IO queue comprises:
means for removing a designation of a second IO queue as having an IO processing priority greater than that of a first IO queue according to at least one of: an elapsed time; and a number of processing operations completed.

18. A non-transitory computer-readable medium including computer-readable instructions for execution of a process on a processing device, the process comprising:
processing one or more input/output (IO) requests in a first IO queue associated with a first device group;
detecting a queuing of one or more IO requests in a second IO queue associated with a second device group;
pausing the processing one or more input/output (IO) requests in a first IO queue associated with a first device group upon a detection of a queuing of one or more IO requests in a second IO queue associated with a second device group;
processing the one or more IO requests in a second IO queue associated with a second device group; and
resuming the processing one or more input/output (IO) requests in a first IO queue associated with a first device group upon a completion of the processing the one or more IO requests in a second IO queue associated with a second device group.
